(19) United States
(12) Patent Application Publication
(10) Pub. No.: US 2026/0292097 A1
(43) Pub. Date: Sep. 24, 2026

(54) IMAGE GENERATION APPARATUS, IMAGE GENERATION METHOD, AND NON-TRANSITORY COMPUTER READABLE MEDIUM FOR IMAGE GENERATION PROGRAM

(71) Applicant: Honda Motor Co., Ltd., Tokyo (JP)

(72) Inventors: Yosuke Fuchiwaki, Tokyo (JP); Hiroshi Honda, Tokyo (JP); Ko Uchida, Tokyo (JP); Kazuki Yoshigai, Tokyo (JP); Shotaro Nishimura, Tokyo (JP)

(21) Appl. No.: 19/568,990

(22) Filed: Mar. 17, 2026

(30) Foreign Application Priority Data
Mar. 21, 2025 (JP) 2025-047518

(51) Int. Cl. H04N 5/91; G06V 20/58; G06V 20/59

(52) U.S. Cl. CPC H04N 5/91; G06V 20/58; G06V 20/59

(57) ABSTRACT

An image generation apparatus includes: a first imaging device configured to capture an image of an interior of a subject vehicle including an occupant; a second imaging device configured to capture an image of surroundings of the subject vehicle; a microprocessor; and a memory connected to the microprocessor. The microprocessor is configured to perform: acquiring an exterior image of the subject vehicle; and synthesizing at least one of an in-vehicle image acquired by the first imaging device and an out-of-vehicle image acquired by the second imaging device with the exterior image to generate a record image.

### CROSS-REFERENCE TO RELATED APPLICATION

This application is based upon and claims the benefit of priority from Japanese Patent Application No. 2025-047518 filed on Mar 21, 2025, the content of which is incorporated herein by reference.

### BACKGROUND

### Technical Field

The present disclosure relates to an image generation apparatus, an image generation method, and a non-transitory computer readable medium storing image generation program for generating an image.

### Related Art

Conventionally, there is known a device configured to generate a composite image in which a subject in a vehicle is arranged with a scenery outside the vehicle as the background on the basis of an image captured by a vehicle-mounted camera that captures the subject in the vehicle and an image captured by a vehicle-mounted camera that captures the scenery outside the vehicle (for example, see JP 2020-095406 A).

However, as in the device disclosed in JP 2020-095406 A, when the subject in the vehicle is simply arranged on the image of the scenery outside the vehicle, the generated composite image may deviate significantly from the actual situation and is therefore not preferable as a record image.

### SUMMARY

An aspect of the present invention is an image generation apparatus including: a first imaging device configured to capture an image of an interior of a subject vehicle including an occupant; a second imaging device configured to capture an image of surroundings of the subject vehicle; a microprocessor; and a memory connected to the microprocessor. The microprocessor is configured to perform: acquiring an exterior image of the subject vehicle; and synthesizing at least one of an in-vehicle image acquired by the first imaging device and an out-of-vehicle image acquired by the second imaging device with the exterior image to generate a record image.

An aspect of the present invention is an image generation method including: acquiring an in-vehicle image acquired by a first imaging device configured to capture an image of an interior of a subject vehicle including an occupant, from the first imaging device; acquiring an out-of-vehicle image acquired by a second imaging device configured to capture an image of surroundings of the subject vehicle, from the second imaging device; acquiring an exterior image of the subject vehicle stored in a memory, from the memory; and synthesizing at least one of the in-vehicle image and the out-of-vehicle image with the exterior image to generate a record image.

Still an aspect of the present invention is a computer-readable storage medium storing an image generation program. The image generation program causes a computer to perform: acquiring an in-vehicle image acquired by a first imaging device configured to capture an image of an interior of a subject vehicle including an occupant, from the first imaging device; acquiring an out-of-vehicle image acquired by a second imaging device configured to capture an image of surroundings of the subject vehicle, from the second imaging device; acquiring an exterior image of the subject vehicle stored in a memory, from the memory; and synthesizing at least one of the in-vehicle image and the out-of-vehicle image with the exterior image to generate a record image.

### BRIEF DESCRIPTION OF THE DRAWINGS

The objects, features, and advantages of the present invention will become clearer from the following description of embodiments in relation to the attached drawings, in which:

FIG. 1 is a block diagram schematically illustrating an overall configuration of a system including an image generation apparatus according to an embodiment of the present invention;

FIG. 2 is a block diagram illustrating a main configuration of the image generation apparatus illustrated in FIG. 1;

FIG. 3 is a diagram illustrating an example of a record image;

FIG. 4 is a diagram illustrating another example of the record image;

FIG. 5 is a diagram illustrating another example of the record image;

FIG. 6 is a diagram illustrating another example of the record image;

FIG. 7 is a block diagram illustrating a main configuration of the user terminal illustrated in FIG. 1; and

FIG. 8 is a flowchart illustrating an example of processing executed by the controller in FIG. 2.

### DETAILED DESCRIPTION

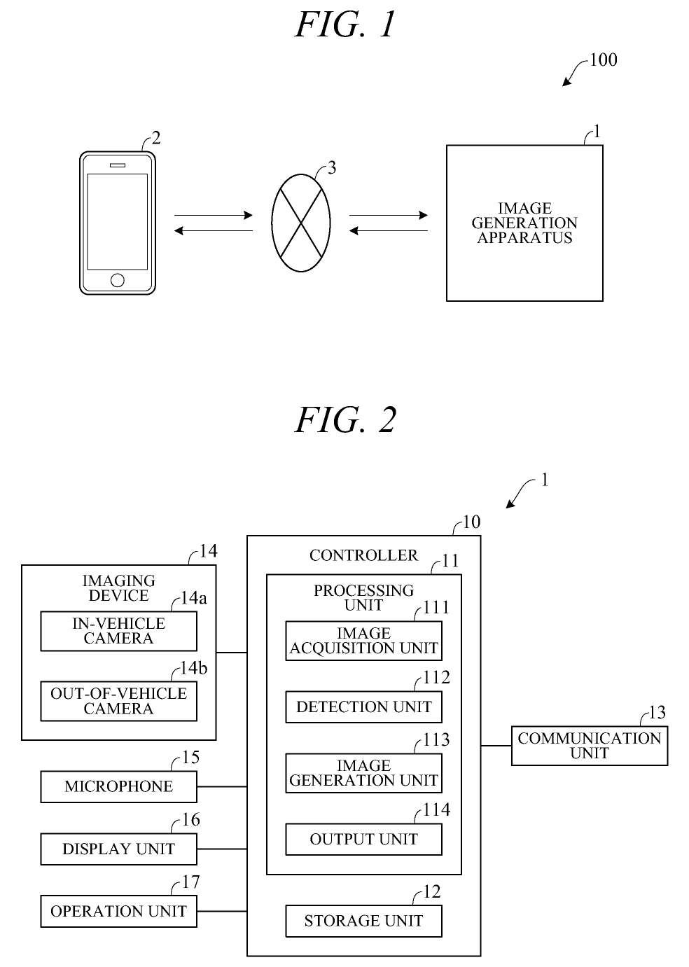

Hereinafter, an embodiment of the invention will be described with reference to the drawings. An image generation apparatus according to the embodiment of the present invention is a device for generating record images for allowing an occupant to look back on memories of trips or drives by vehicle on the basis of image data acquired by a vehicle-mounted camera. Note that a vehicle to which the image generation apparatus according to the present embodiment is applied may be referred to as a subject vehicle so as to be distinguished from other vehicles. FIG. 1 is a block diagram schematically illustrating an overall configuration of a system 100 including an image generation apparatus 1 according to the present embodiment. As illustrated in FIG. 1, the system 100 includes the image generation apparatus 1 and a user terminal 2.

The image generation apparatus 1 and the user terminal 2 are communicably connected via a communication network 3. The communication network 3 includes not only a public wireless communication network, such as the Internet network or a mobile communication network, but also a closed communication network provided for each predetermined management region, such as a wireless LAN, Wi-Fi (registered trademark), or Bluetooth (registered trademark).

The user terminal 2 is a communication terminal, such as a smartphone, and is used by a user of the subject vehicle, such as an occupant. Note that, although a single user terminal 2 is illustrated in FIG. 1, the system 100 includes a user terminal 2 corresponding to each user.

FIG. 2 is a block diagram illustrating a main configuration of the image generation apparatus 1 illustrated in FIG. 1. The image generation apparatus 1 includes a controller 10, a communication unit 13, an imaging device 14, a microphone (hereinafter, simply referred to as a mic) 15, a display unit 16, and an operation unit 17. The communication unit 13 is a communication interface that connects the image generation apparatus 1 to the communication network 3. The image generation apparatus 1 transmits and receives information to and from the user terminal 2 or the like connected to the communication network 3 via the communication unit 13.

The imaging device 14 includes a camera 14a that captures an interior of the subject vehicle (hereinafter, referred to as an in-vehicle camera) and a camera 14b that captures surroundings of the subject vehicle (hereinafter, referred to as an out-of-vehicle camera). Each of the cameras 14a and 14b includes an imaging element such as a CCD or a CMOS. Image data captured by the cameras 14a and 14b is output to a processing unit 11. The mic 15 receives in-vehicle audio as an audio signal. The audio signal input by the mic 15 is output to the processing unit 11 as audio data via an A/D converter (not illustrated).

The display unit 16 includes a display device provided with a touch panel, such as a liquid crystal display or an organic EL display. The operation unit 17 includes the touch panel provided in the display unit 16 and is capable of receiving various instructions from the user. Note that the operation unit 17 may include an input device such as a switch or a button.

The controller 10 includes a computer provided with the processing unit 11 such as a CPU (microprocessor), a storage unit 12 such as a ROM and a RAM, and other peripheral circuits (not illustrated) such as an I/O interface. The processing unit 11 functions as an image acquisition unit 111, a detection unit 112, an image generation unit 113, and an output unit 114 by executing a program stored in the storage unit 12.

The image acquisition unit 111 acquires image data indicating an exterior of the subject vehicle (hereinafter, referred to as exterior image data or simply as an exterior image). More specifically, the image acquisition unit 111 acquires the exterior image stored in the storage unit 12 via readout.

Note that the exterior image is stored in advance in the storage unit 12 in accordance with a registration command to be described later. Specifically, upon receipt of the registration command from the user terminal 2, the image acquisition unit 111 stores the exterior image received together with the registration command in the storage unit 12.

Further, the image acquisition unit 111 acquires image data captured by the in-vehicle camera 14a (hereinafter, referred to as in-vehicle image data or simply as an in-vehicle image). Furthermore, the image acquisition unit 111 acquires image data captured by the out-of-vehicle camera 14b (hereinafter, referred to as out-of-vehicle image data or simply as an out-of-vehicle image).

The detection unit 112 detects a specific location (a specific landmark or a specific area) present around the subject vehicle on the basis of the out-of-vehicle image. Specifically, the detection unit 112 detects the specific location using a multimodal large language model (LLM) with the out-of-vehicle image as an input. The specific landmark includes historic sites, distinctive buildings and natural features, famous scenic spots, signboards, and the like. The specific area includes prefectural borders, spectacular landscapes (scenery), and the like. Note that the detection unit 112 may detect the specific location present around the subject vehicle on the basis of map information stored in the storage unit 12 and the current position of the subject vehicle detected by a vehicle-mounted sensor (positioning sensor) (not illustrated).

The detection unit 112 further detects a specific in-vehicle situation on the basis of the in-vehicle image. The specific in-vehicle situation is a state in which the occupant is excited by some topic or is surprised by scenery visible through a window. The detection unit 112 recognizes an emotion based on the facial expression of the occupant using a machine learning model, more specifically, an emotion classification model with the in-vehicle image as an input, and detects the specific in-vehicle situation on the basis of the recognition result.

The emotion recognition result of the emotion classification model includes numerical emotion scores, one for each of the emotions of the occupant (such as “excitement”, “surprise”, “happiness”, “anger”, and “sadness”), ranging from 0.0 (none) to 1.0 (maximum). The detection unit 112 determines that the occupant is excited or surprised when an emotion score corresponding to a predetermined emotion (such as “excitement” or “surprise”) exceeds a predetermined threshold. As described above, the detection unit 112 detects the specific in-vehicle situation.

Note that the detection unit 112 may detect the specific in-vehicle situation on the basis of the audio data acquired by the mic 15 (hereinafter, referred to as in-vehicle audio data or simply as in-vehicle audio). In this case, the detection unit 112 recognizes an emotion based on a voice or utterance volume of the occupant using the emotion classification model with the in-vehicle audio as an input. Further, the detection unit 112 may detect the specific in-vehicle situation on the basis of the in-vehicle image and the in-vehicle audio.

The detection unit 112 further detects an attention direction of the occupant on the basis of the in-vehicle image. Specifically, the detection unit 112 detects a face orientation, eye positions, eye movements, and the like of the occupant included in the in-vehicle image, and estimates a gaze direction of the occupant on the basis of the detection result. When the estimated gaze direction remains unchanged for a predetermined time, the detection unit 112 detects the gaze direction as the attention direction.

Note that the detection unit 112 may detect the attention direction on the basis of a gesture (such as pointing with a finger) of the occupant recognized on the basis of the in-vehicle image. Further, the detection unit 112 may recognize the content of the conversation of the occupant on the basis of the in-vehicle audio, and when the conversation of the occupant includes a phrase indicating a direction such as “front”, “right”, “south”, or “east”, the detection unit 112 may detect the attention direction on the basis of the phrase. Furthermore, the detection unit 112 may estimate the gaze using the machine learning model, more specifically, a gaze estimation model with the in-vehicle image as an input, and detect the attention direction on the basis of the estimation result.

The image generation unit 113 combines at least one of the in-vehicle image and the out-of-vehicle image, and the exterior image using the multimodal LLM to generate record image data (hereinafter, also simply referred to as a record image). Note that, in a case where the image acquisition unit 111 acquires a plurality of exterior images from the storage unit 12, the plurality of exterior images may be used to generate the record image data. Here, the generation of the record image using the image generation unit 113 will be described.

When the specific in-vehicle situation is detected by the detection unit 112, the image generation unit 113 generates a record image representing the specific in-vehicle situation on the basis of the in-vehicle image. At this time, the image generation unit 113 generates a prompt (instruction) to be input into the multimodal LLM so that at least an occupant who is excited or surprised is included in the record image.

Examples of the prompt include “generate an image representing an in-vehicle scene so that an occupant who is excited or surprised is included in the image”. The image generation unit 113 inputs the generated prompt into the multimodal LLM together with the in-vehicle image. As a result, a record image representing the specific in-vehicle situation is generated by the multimodal LLM.

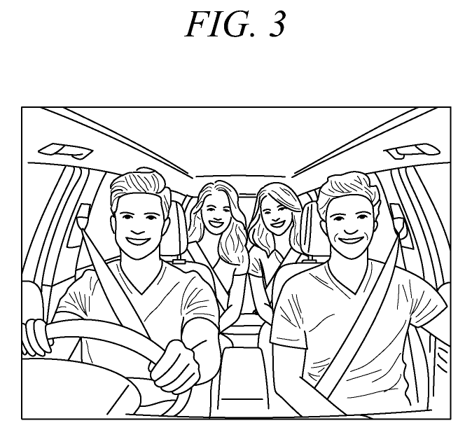

FIG. 3 is a diagram illustrating an example of the record image. FIG. 3 illustrates a record image representing a specific in-vehicle situation, specifically, an in-vehicle situation where occupants are excited about their friend’s love life. Note that, as illustrated in FIG. 3, the record image is preferably generated so as to include all the occupants.

On the other hand, when a specific location is detected by the detection unit 112, the image generation unit 113 generates a record image including the subject vehicle and the specific location on the basis of the out-of-vehicle image and the exterior image. At this time, the image generation unit 113 generates a prompt to be input into the multimodal LLM so that a record image of the subject vehicle as if captured with the specific location as the background is generated.

Examples of the prompt include “generate an image capturing the subject vehicle with a specific landmark or area as the background”. The image generation unit 113 inputs the generated prompt into the multimodal LLM together with the out-of-vehicle image and the exterior image. As a result, in a case where the out-of-vehicle image includes Mount Fuji, Tokyo Tower, or the like, the multimodal LLM generates a record image of the subject vehicle as if captured with such a landmark as the background.

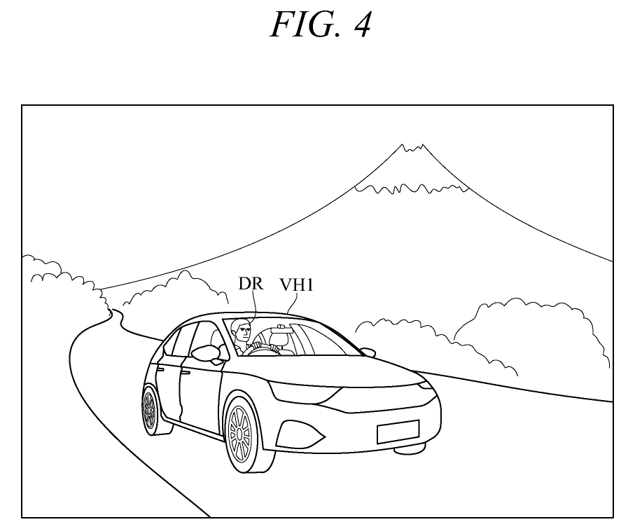

FIG. 4 is a diagram illustrating another example of the record image. FIG. 4 illustrates a record image of the subject vehicle as if captured with a specific location (Mount Fuji) visible behind the vehicle as the background. Normally, even when an occupant drives a stylish or preferred vehicle, the occupant cannot capture and record an image capturing the vehicle in motion from outside the vehicle. However, as illustrated in FIG. 4, by generating a record image that includes the exterior of the subject vehicle (vehicle VH1), it is possible to provide the user with an image of the vehicle in which the user is driving or riding as if captured from outside the vehicle. Further, as illustrated in FIG. 4, by generating a record image that includes a user DR who is an occupant, it is possible to provide an image that closely approximates the actual situation.

When both the specific in-vehicle situation and the specific location are detected by the detection unit 112, the image generation unit 113 generates a record image including the occupant in the vehicle, the subject vehicle, and the specific location on the basis of the in-vehicle image, the out-of-vehicle image, and the exterior image. At this time, in a case where the attention direction of the occupant is detected by the detection unit 112, the image generation unit 113 generates a record image captured at a camera angle considering the attention direction. Specifically, the image generation unit 113 generates a prompt to be input into the multimodal LLM so that a record image captured at a camera angle considering the attention direction is generated.

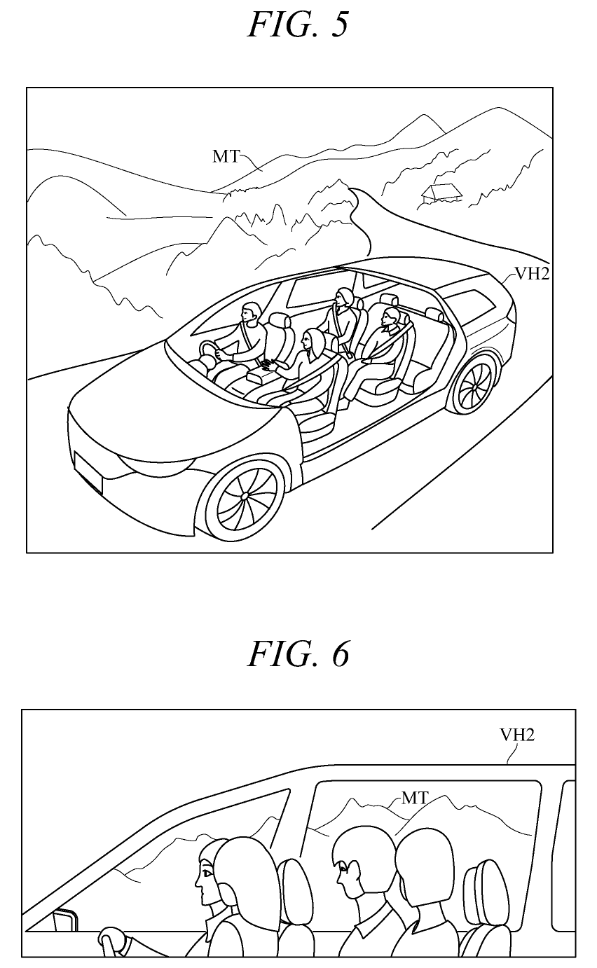

Examples of the prompt include “generate an image of the subject vehicle as if captured with a specific landmark or area as the background from a direction opposite to the attention direction at a camera angle oriented toward the attention direction”. The image generation unit 113 inputs the generated prompt into the multimodal LLM together with the information indicating the attention direction, the out-of-vehicle image, and the exterior image. As a result, a record image as illustrated in FIG. 5 to be described later is generated by the multimodal LLM.

FIG. 5 is a diagram illustrating another example of the record image. FIG. 5 illustrates a record image generated in a case where the occupants pay attention to a specific location (a majestic mountain range MT) visible on the right side of the vehicle. Specifically, illustrated is a record image of the subject vehicle (vehicle VH2) as if captured with the mountain range MT as the background from a direction opposite to the attention direction (i.e., from the left side of the vehicle, which is opposite to the direction toward the mountain range MT) at a camera angle oriented toward the attention direction.

Note that, as in the example illustrated in FIG. 5, the image generation unit 113 may add an additional instruction to the prompt to be input into the multimodal LLM so that a part of the vehicle body that blocks the occupants (in the example illustrated in FIG. 5, the right side and front-right portion of the vehicle body) is removed when viewed from the viewpoint of the record image. Examples of the additional instruction include “make the vehicle a cutaway model so that the occupants in the vehicle are visible”. This enables the user to easily look back on the in-vehicle scene when the specific location is detected using the record image.

Further, the image generation unit 113 may generate a prompt to be input into the multimodal LLM so that a record image including a specific location visible through the windshield, rear window, or side window from inside the vehicle and an occupant in the vehicle is generated.

Examples of the prompt include “generate an image including a specific landmark and area visible through a window from inside the vehicle and an occupant viewing the landmark and area”. The image generation unit 113 inputs the generated prompt into the multimodal LLM together with the in-vehicle image and the out-of-vehicle image. As a result, a record image as illustrated in FIG. 6 to be described later is generated by the multimodal LLM.

FIG. 6 is a diagram illustrating another example of the record image. FIG. 6 illustrates a record image including a specific location (mountain range MT) visible through the right side window from inside the vehicle VH2 illustrated in FIG. 5 and occupants viewing the specific location. Even with the record image as illustrated in FIG. 6, the user can look back on the in-vehicle scene when the specific location is detected using the record image. The image generation unit 113 may generate both the record image as illustrated in FIG. 5 and the record image as illustrated in FIG. 6.

The output unit 114 outputs the record image generated by the image generation unit 113 to the storage unit 12. As a result, the record image is stored in the storage unit 12. Note that the output unit 114 may output the record image to an external device (e.g., a server device or a storage device) via the communication unit 13. Further, upon receipt of a transmission command to be described later from the user terminal 2, the output unit 114 reads the record image from the storage unit 12 and outputs (transmits) the record image to the user terminal 2.

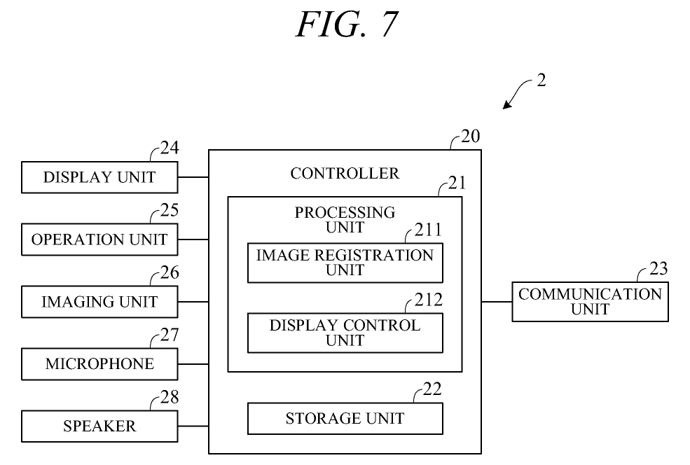

FIG. 7 is a block diagram illustrating a main configuration of the user terminal 2 illustrated in FIG. 1. The user terminal 2 includes a controller 20, a communication unit 23, a display unit 24, an operation unit 25, an imaging unit 26, a mic 27, and a speaker 28. A storage unit 22 stores programs for various types of control and information such as thresholds used in the programs.

The communication unit 23 is a communication interface that connects the user terminal 2 to the communication network 3. The display unit 24 includes a display device provided with a touch panel, such as a liquid crystal display or an organic EL display. The operation unit 25 includes the touch panel provided in the display unit 24, and is capable of receiving various instructions from the user.

The imaging unit 26 includes a camera including an imaging element such as a CCD or a CMOS. Captured image data acquired by the imaging unit 26 is output to a processing unit 21. The mic 27 receives ambient audio as an audio signal. The audio signal input by the mic 27 is output to the processing unit 21 as audio data via an A/D converter (not illustrated). The speaker 28 outputs the audio data received from the processing unit 21 as an audio signal via a D/A converter (not illustrated).

The controller 20 includes a computer provided with the processing unit 21 such as a microprocessor (CPU), the storage unit 22 such as a ROM and a RAM, and other peripheral circuits (not illustrated) such as an I/O interface. The processing unit 21 functions as an image registration unit 211 and a display control unit 212 by executing a program stored in the storage unit 22.

The image registration unit 211 receives a request to register the exterior image of the subject vehicle from the user. Specifically, first, the image registration unit 211 generates screen information for receiving the request to register the exterior image, and outputs the screen information to the display unit 24. As a result, a registration request reception screen (not illustrated) is displayed on the display unit 24. Note that the image registration unit 211 may output the above screen information to the display unit 24 when a predetermined application installed on the user terminal 2 is activated, or may output the screen information at another timing.

The user operates the imaging unit 26 via the operation unit 25 to capture the exterior of the subject vehicle in advance. As a result, the captured image (exterior image) acquired by the imaging unit 26 is stored in the storage unit 22 of the user terminal 2. The user operates the registration request reception screen via the operation unit 25 to select the exterior image of the subject vehicle stored in the storage unit 22 and request the registration of the exterior image.

Upon receipt of the request to register the exterior image from the user, the image registration unit 211 reads the exterior image selected by the user from the storage unit 22, and transmits the exterior image and the registration command to the image generation apparatus 1 via the communication unit 23.

The display control unit 212 receives a request to display the record image from the user. Specifically, first, the image registration unit 211 generates screen information for receiving the request to display the record image, and outputs the screen information to the display unit 24. As a result, a display request reception screen (not illustrated) is displayed on the display unit 24. Note that the display control unit 212 may output the screen information to the display unit 24 when a predetermined application installed on the user terminal 2 is activated, or may output the screen information at another timing.

The user operates the display request reception screen via the operation unit 25 to request the display of the record image. Upon receipt of the request to display the record image from the user, the display control unit 212 transmits a transmission command for the record image to the image generation apparatus 1 via the communication unit 23. Upon receipt of the record image transmitted from the output unit 114 of the image generation apparatus 1 in response to the transmission command, the display control unit 212 outputs the record image to the display unit 24. As a result, the record image is displayed on the display unit 24.

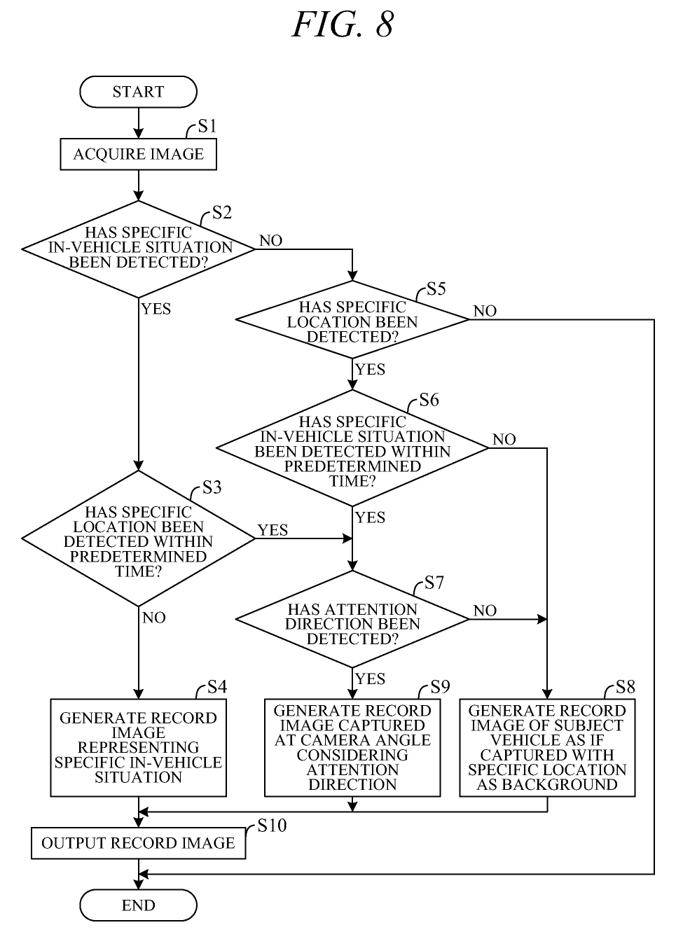

FIG. 8 is a flowchart illustrating an example of processing executed by the controller 10 of the image generation apparatus 1 in accordance with a predetermined program. The processing illustrated in the flowchart is started when the controller 10 is activated, and is repeated at a predetermined cycle.

First, in step S1, the controller 10 acquires in-vehicle image and out-of-vehicle image via the imaging device 14. Further, the controller 10 acquires the exterior image of the subject vehicle from the storage unit 12. In step S2, the controller 10 determines whether a specific in-vehicle situation has been detected on the basis of the in-vehicle image. In a case where the determination in step S2 is negative, the controller 10 determines in step S3 whether a specific location has been detected within a predetermined time after detecting the specific in-vehicle situation in step S2.

In a case where the determination in step S3 is affirmative, the controller 10 proceeds to step S7. In a case where the determination in step S3 is negative, the controller 10 generates a record image representing the specific in-vehicle situation on the basis of the in-vehicle image in step S4.

In a case where the determination in step S2 is negative, the controller 10 determines in step S5 whether the specific location has been detected on the basis of the out-of-vehicle image. In a case where the determination in step S5 is negative, the controller 10 terminates the processing. In a case where the determination in step S5 is affirmative, it is determined in step S6 whether the specific in-vehicle situation has been detected within a predetermined time after detecting the specific location in step S2.

In a case where the determination in step S6 is affirmative, the controller 10 determines in step S7 whether the attention direction of the occupant has been detected on the basis of the in-vehicle image. In a case where the determination in step S6 or S7 is negative, the controller 10 generates, on the basis of the out-of-vehicle image and the exterior image, a record image of the subject vehicle as if captured with the specific location as the background in step S8.

In a case where the determination in step S7 is affirmative, the controller 10 generates a record image captured at a camera angle considering the attention direction on the basis of the in-vehicle image, the out-of-vehicle image, and the exterior image in step S9. More specifically, the controller 10 generates a record image of the subject vehicle as if captured with the specific location as the background from a direction opposite to the attention direction at a camera angle oriented toward the attention direction. In step S10, the controller 10 outputs the record image generated in steps S7, S8, and S9 to the storage unit 12.

According to the above-described embodiment, the following effects can be achieved.
(1) An image generation apparatus 1 includes: an in-vehicle camera 14a serving as a first imaging device configured to capture an interior of a vehicle including an occupant; an out-of-vehicle camera 14b serving as a second imaging device configured to capture surroundings of a subject vehicle; an image acquisition unit 111 serving as an acquisition unit configured to acquire an exterior image of the subject vehicle from the storage unit 12 via readout; and an image generation unit 113 serving as a generation unit configured to generate a record image by combining at least one of an in-vehicle image acquired by the in-vehicle camera 14a and an out-of-vehicle image acquired by the out-of-vehicle camera 14b, and the exterior image acquired by the image acquisition unit 111. The image acquisition unit 111 acquires the exterior image from the storage unit 12 via readout. As described above, by including the exterior image of the subject vehicle in the record image (composite image), the generated composite image can be an image that reproduces the actual situation or approximates the actual situation. As a result, the user can easily look back on the actual scenes during a trip or a drive using the record image.
(2) The image generation apparatus 1 further includes a detection unit 112 configured to detect a specific landmark or a specific area present around the subject vehicle on the basis of the out-of-vehicle image acquired by the out-of-vehicle camera 14b. When the specific landmark or the specific area is detected by the detection unit 112, the image generation unit 113 generates a record image (FIGS. 4, 5, and 6, ) including the subject vehicle and the detected specific landmark or specific area. This enables the user to recall locations actually visited by the vehicle during a trip or a drive using the record image.
(3) The detection unit 112 further detects a specific in-vehicle situation on the basis of the in-vehicle image. When the specific in-vehicle situation and either the specific landmark or the specific area are detected by the detection unit 112, the image generation unit 113 generates a record image (FIG. 5) on the basis of the in-vehicle image, the out-of-vehicle image, and the exterior image. This enables the user to easily look back on scenes including in-vehicle situations during a trip or a drive using the record image.
(4) The detection unit 112 further detects an attention direction of an occupant on the basis of the in-vehicle image. The image generation unit 113 generates a record image (FIG. 5) captured at a camera angle oriented toward the attention direction. This enables the user to recall landmarks and the like that caught the user’s attention during a trip or a drive using the record image.
(5) The image generation unit 113 generates a record image (FIG. 6) including a specific landmark or a specific area visible through a window from inside the vehicle and an occupant in the vehicle on the basis of the in-vehicle image and the out-of-vehicle image. This enables the user to recall the actual atmosphere and feel during a trip or a drive using the record image.
(6) The image generation unit 113 combines the in-vehicle image, the out-of-vehicle image, and the exterior image using a multimodal LLM. This enables the generation of a record image using a prompt written in natural language as an instruction, thereby enabling the generation of a record image better tailored to the actual scenes and atmosphere.
(7) The image generation unit 113 generates a record image (FIG. 3) on the basis of the in-vehicle image without using the exterior image when a specific in-vehicle situation is detected by the detection unit 112 while neither a specific landmark nor a specific area is detected by detection unit 112. This enables only the in-vehicle scene when the specific in-vehicle situation occurs to be stored in the record image, thereby enabling the user to easily look back on the specific in-vehicle situation that is unrelated to the out-of-vehicle environment using the record image.

The above embodiment may be modified into various forms. Hereinafter, modifications will be described. In the above embodiment, the image generation unit 113 generates a record image (FIG. 6) including a specific landmark or a specific area visible through a window from inside the vehicle and an occupant in the vehicle on the basis of the in-vehicle image and the out-of-vehicle image. However, the image generation unit may reduce the display size of the specific landmark and the like visible through the window on the record image so that the specific landmark and the like fit within the window frame. Furthermore, in a case where the size of the specific landmark and the like visible through the window on the record image is too small, specifically, in a case where the ratio of the specific landmark and the like to the entire window frame is less than a predetermined value, the image generation unit may increase the display size of the specific landmark and the like.

Furthermore, in the above embodiment, the image generation unit 113 generates a record image of the subject vehicle (FIG. 5) as if captured with a specific landmark or a specific area as the background. However, in a case where a specific landmark and the like include a large natural feature (such as a mountain or the sea) or a structure (such as a high-rise building), the image generation unit may generate a record image as if captured by a drone or the like so that the entire natural feature or structure fits within the image. Further, in a case where the visibility of the subject vehicle is reduced due to an attempt to fit the specific landmark or specific area within the image, specifically, in a case where the proportion of the subject vehicle in the entire image is less than a predetermined value, the display size of the subject vehicle may be increased. Alternatively, maintaining the proportion of the subject vehicle in the entire image above the predetermined value may be prioritized rather than fitting the specific landmark or specific area within the image.

As another aspect, the image generation apparatus of the above embodiment may be configured as an image generation method including: acquiring, from a first imaging device configured to capture an interior of a vehicle including an occupant, an in-vehicle image acquired by the first imaging device; acquiring, from a second imaging device configured to capture surroundings of a subject vehicle, an out-of-vehicle image acquired by the second imaging device; acquiring, from a storage unit, an exterior image of the subject vehicle stored in the storage unit; and generating a record image by combining at least one of the in-vehicle image and the out-of-vehicle image, and the exterior image.

Furthermore, the present invention may be configured by replacing the above image generation method with a program for causing a computer to execute processing of generating a record image for an occupant to look back on memories of trips or drives by vehicle. Furthermore, the present invention may also be configured by replacing the program with a computer-readable storage medium in which the program is recorded.

The above embodiment can be combined as desired with one or more of the aforesaid modifications. The modifications can also be combined with one another.

According to the present invention, the generated composite image can be an image that reproduces the actual situation or approximates the actual situation, thereby enabling the generation of a record image suitable for looking back on memories.

Above, while the present invention has been described with reference to the preferred embodiments thereof, it will be understood, by those skilled in the art, that various changes and modifications may be made thereto without departing from the scope of the appended claims.

What is claimed is:

1. An image generation apparatus comprising:
a first imaging device configured to capture an image of an interior of a subject vehicle including an occupant;
a second imaging device configured to capture an image of surroundings of the subject vehicle;
a microprocessor; and a memory connected to the microprocessor, wherein
the microprocessor is configured to perform:
acquiring an exterior image of the subject vehicle; and
synthesizing at least one of an in-vehicle image acquired by the first imaging device and an out-of-vehicle image acquired by the second imaging device with the exterior image to generate a record image.

2. The image generation apparatus according to claim 1, wherein
the memory stores the exterior image, and
the microprocessor is further configured to perform:
the acquiring including acquiring the exterior image from the memory.

3. The image generation apparatus according to claim 1, wherein
the microprocessor is further configured to perform:
detecting a specific landmark or a specific area present around the subject vehicle based on the out-of-vehicle image acquired by the second imaging device, and
when the specific landmark or the specific area is detected, generating the record image including the subject vehicle and the specific landmark or the specific area.

4. The image generation apparatus according to claim 3, wherein
the microprocessor is configured to perform:
the detecting including detecting a specific in-vehicle situation based on the in-vehicle image; and
the generating including, when the specific in-vehicle situation and the specific landmark or the specific area are detected, generating the record image based on the in-vehicle image, the out-of-vehicle image, and the exterior image.

5. The image generation apparatus according to claim 4, wherein
the microprocessor is configured to perform:
the detecting including further detecting an attention direction of the occupant based on the in-vehicle image; and
the generating including generating the record image with a camera angle oriented in the attention direction.

6. The image generation apparatus according to claim 1, wherein
the microprocessor is further configured to perform:
detecting a specific landmark or a specific area present around the subject vehicle based on the out-of-vehicle image acquired by the second imaging device; and
generating the record image including the specific landmark or the specific area visible through a window from inside the subject vehicle and the occupant in the interior of the subject vehicle, based on the in-vehicle image and the out-of-vehicle image.

7. The image generation apparatus according to claim 1, wherein
the microprocessor is configured to perform:
the generating including synthesizing the in-vehicle image, the out-of-vehicle image, and the exterior image using a multimodal LLM (large language model).

8. The image generation apparatus according to claim 3, wherein
the record image is a first record image, and
the microprocessor is configured to perform:
the generating including generating a second record image based on the in-vehicle image without using the exterior image when the specific in-vehicle situation is detected in a state where neither the specific landmark or the specific area are detected.

9. An image generation method comprising:
acquiring an in-vehicle image acquired by a first imaging device configured to capture an image of an interior of a subject vehicle including an occupant, from the first imaging device;
acquiring an out-of-vehicle image acquired by a second imaging device configured to capture an image of surroundings of the subject vehicle, from the second imaging device;
acquiring an exterior image of the subject vehicle stored in a memory, from the memory; and
synthesizing at least one of the in-vehicle image and the out-of-vehicle image with the exterior image to generate a record image.

10. A computer-readable storage medium storing an image generation program, wherein
the image generation program causes a computer to perform:
acquiring an in-vehicle image acquired by a first imaging device configured to capture an image of an interior of a subject vehicle including an occupant, from the first imaging device;
acquiring an out-of-vehicle image acquired by a second imaging device configured to capture an image of surroundings of the subject vehicle, from the second imaging device;
acquiring an exterior image of the subject vehicle stored in a memory, from the memory; and
synthesizing at least one of the in-vehicle image and the out-of-vehicle image with the exterior image to generate a record image.
